(19) United States
(12) Patent Application Publication
(10) Pub. No.: US 2006/0145676 A1
(43) Pub. Date: Jul. 6, 2006

(54) Method and circuit arrangement for a power supply

(75) Inventor: Ullrich Drusenthal, Heilbronn (DE)

Correspondence Address: MCGRATH, GEISSLER, OLDS & RICHARDSON, PLLC, P.O. BOX 1364, FAIRFAX, VA, 22038-1364, US

(73) Assignee: ATMEL GERMANY GMBH, Heilbronn (DE)

(21) Appl. No.: 11/354,151

(22) Filed: Feb. 15, 2006

Related U.S. Application Data
(63) Continuation of application No. PCT/EP04/09079, filed on Aug. 13, 2004.

(30) Foreign Application Priority Data
Aug. 15, 2003 (DE) 103 38 272.0

(51) Int. Cl. G05F 1/40; G05F 1/618

(52) U.S. Cl. 323/282

(57) ABSTRACT

A power supply circuit arrangement is provided that includes a switching regulator for generating a first regulated voltage, a controlled load element that is impinged upon by the first regulated voltage, and a first control element for controlling the load element. A method for generating a supply voltage is also provided. The switching regulator is adapted to generate a second, unregulated voltage that serves directly or indirectly as a supply voltage for the first control element. The circuit arrangement and method are used for example for a battery-based power supply of electric automotive components.

This nonprovisional application is a continuation of International Application PCT/EP2004/009079, which was filed on Aug. 13, 2004, and which claims priority to German Patent Application No. DE 103 38 272.0, which was filed on Aug. 15, 2003, and which are all herein incorporated by reference.

### BACKGROUND OF THE INVENTION

1. Field of the Invention

The invention relates to a circuit arrangement for a power supply and to a method for generating a supply voltage.

2. Description of the Background Art

In battery-supplied systems, in cases in which considerable variations in a battery voltage occur, there is often the need to generate therefrom a stable system voltage or supply voltage. The battery voltage varies greatly particularly in vehicles and at times, for example, during a starter or starting procedure for the vehicle and thus may be lower than a desired supply voltage. Circuit arrangements for a battery-based power supply are customary for this purpose; these comprise one or more linear regulators, which, for example, in the case of sensors, analog circuit components, and microprocessors, generate a precise and stable supply voltage, which is substantially free of interfering residual or so-called “ripples.” Because linear regulators, due to their internal construction, require an input voltage that is higher than an output voltage, and their power dissipation depends on a voltage difference between the input and output voltage and an output load, switching regulators are inserted between the battery and the linear regulators. Switching regulators are suitable for low-dissipation generation of an output voltage, which may be considerably higher or lower than the input voltage. Their output voltage, however, typically has some residual ripple, so that it is often not directly suitable for generating a supply voltage for a circuit component sensitive to this.

If the input voltage may be both higher and lower than the voltage to be generated from it, switching regulators are used, which can regulate in both the up and down direction. Examples of these are single-ended-primary-inductance-converters (SEPIC), flyback converters, and reverse converters.

The output voltage of the switching regulator, which is used as the input voltage of the linear regulator(s), is adjusted to minimize dissipation in such a way that a voltage difference as low as possible becomes established between the input and output voltage of the linear regulator, for example, at about 1.5 V.

A linear regulator normally comprises a controllable load element in the form of an NMOS transistor, which is supplied with the output voltage of the switching regulator, as an actuator and a control element for controlling the transistor. The transistor is looped into a load current path between the output of the switching regulator and the system(s) to be supplied. The overall size of the transistor depends greatly on its gate-source voltage. Conventionally, the control element is supplied with the voltage also applied at the transistor, as a result of which the gate-source voltage of the linear regulator is limited and a minimal overall size is established.

The output voltage of the switching regulator can also be used to supply additional circuit components, which have a controllable load element, which is supplied with the output voltage. In this connection, this can be, for example, a motor regulator, which is operated with the output voltage via a load element in the form of a power transistor. Here as well, the minimum overall size of the power transistor again depends greatly on its gate-source voltage.

### SUMMARY OF THE INVENTION

It is therefore an object of the present invention to provide a circuit arrangement and a method, which can be realized at a relatively low cost and are capable of supplying a stable supply voltage at low dissipation, particularly also from a battery with appreciable battery voltage variations. It is desirable, furthermore, to minimize the overall size of the employed load elements.

The circuit arrangement of the invention includes a switching regulator, which generates, in addition to a first regulated voltage, a second, unregulated voltage, which is used directly or indirectly as a supply voltage for the first control element. The first control element with this supply voltage independent of the first voltage can set a control voltage for the load element in such a way that an advantageous efficiency results and the overall size of the load element(s) is reduced.

In a further embodiment of the circuit arrangement, the second voltage can be higher than the first voltage. This enables the control of the load element with control voltages, which are higher than the voltages applied at the load current path.

In a further embodiment of the circuit arrangement, the controllable load element and the first control element can form a first linear voltage regulator to generate a third regulated voltage from the first voltage. This enables the generation of precise voltages with lower residual ripple with a simultaneously high efficiency.

In a further embodiment of the circuit arrangement, the switching regulator comprises a second control element and the second voltage can serve directly or indirectly as its supply voltage. The second control element can be used, for example, for internal control of the switching regulator and can include one or more comparators, sawtooth generators, and operational amplifiers. The supplying by the second voltage facilitates a startup of the switching regulator at low input voltages.

In a further embodiment of the circuit arrangement, the circuit arrangement comprises a second, linear voltage regulator, which generates a supply voltage for the first control element and/or a second control element from the second voltage. This enables on-demand generation of additional precise voltages for the internal supply. Because the power draw from the second voltage regulator is normally small, the dissipation due to said regulator remains low.

In another further embodiment of the circuit arrangement, a first rectifier element, particularly a diode, is looped in the forward direction, as well as a reference potential of the switching regulator, and a smoothing capacitor in series between a junction point of an input inductor and a switch, the second voltage being available at the junction point of the first rectifier element and smoothing capacitor. The voltage at the junction point of the input inductor and the switch has periodic voltage spikes during operation, which correspond essentially to the sum of the input and output voltage of the switching regulator. The second voltage is obtained herefrom with the help of the first rectifier element and the smoothing capacitor and is higher than the input voltage or the output voltage of the switching regulator.

In a further embodiment of the circuit arrangement, a second rectifier element, for example, a diode, is looped in the forward direction between an input terminal and a node of the switching regulator, to which the second voltage is available. The second rectifier element is used to start the switching regulator, when the input voltage is applied. A possibly not yet available or too low second voltage can then be replaced by the input voltage, which is put through the second rectifier element.

Also, the load element can form an emitter follower or a source follower.

Further, the switching regulator can be constructed as a SEPIC, flyback, or reverse converter. With the aid of converters of this type, output voltages can be generated, which depending on need are higher or lower than their input voltage.

In the method of the invention a second, particularly unregulated voltage is generated by the switching regulator to supply the first control element.

In a further embodiment of the method, the first and the second voltage can be generated in such a way that the second voltage is higher than the first voltage.

In a further embodiment of the method, the controllable load element can be controlled by the first control unit in such a way that a third regulated voltage is generated from the first voltage.

In a further embodiment of the method, a second control element, which controls the switching regulator internally, can be supplied directly or indirectly by the second voltage.

In a further embodiment of the method, a supply voltage for the first control element and/or the second control element can be generated from the second voltage.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a circuit arrangement for a power supply, according to an embodiment of the present invention;

FIG. 2 is a block diagram of a circuit arrangement for a power supply with a SEPIC-type switching regulator; according to another embodiment of the present invention; and

FIG. 3 is a block diagram of a circuit arrangement for a power supply with a flyback-type switching regulator, according to an embodiment of the present invention.

### DETAILED DESCRIPTION

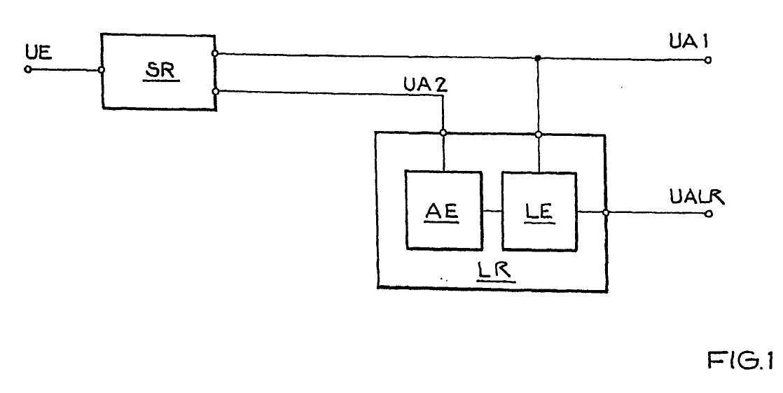

FIG. 1 shows a block diagram of a circuit arrangement for a power supply comprising a switching regulator SR, which generates a first regulated voltage UA1 and a second unregulated voltage UA2 from an input voltage UE, and a linear regulator LR. The linear regulator LR comprises a controllable load element LE, which is supplied with the first voltage UA1 of the switching regulator SR, and a control element AE for controlling the load element LE. The control element AE controls the load element LE in such a way that a regulated voltage UALR, which has a low residual ripple and can be used to supply sensitive downstream circuit components (not shown), is generated from the first voltage UA1 of the switching regulator SR. The second voltage UA2 of the switching regulator SR is used to supply the control element AE.

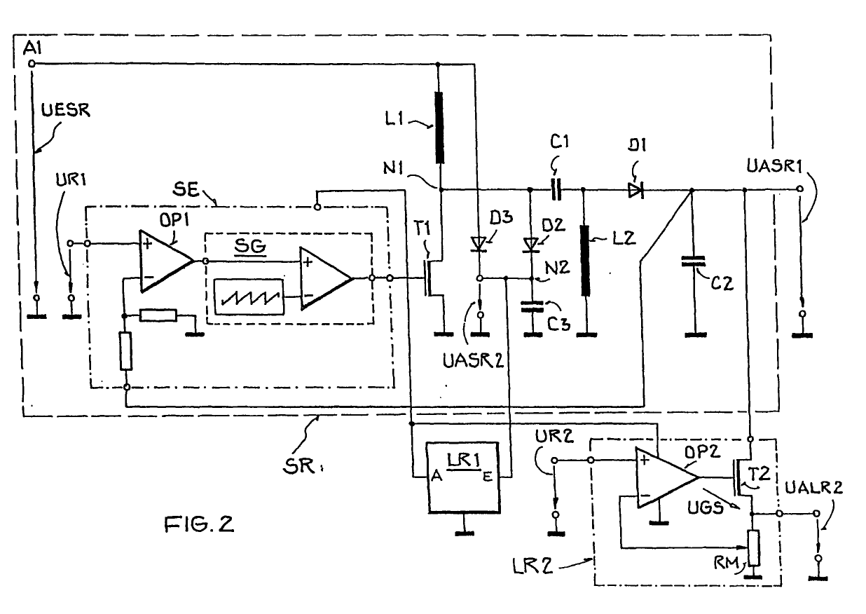

In the circuit arrangement shown in FIG. 2, the switching regulator SR of FIG. 1 is constructed as a SEPIC-type converter. The switching regulator SR generates from an input voltage UESR, provided by a battery (not shown), a regulated output voltage UASR1, which can be selected to be higher or lower than the input voltage UESR. An input inductor L1 and a switch in the form of a transistor T1 are looped in series between an input terminal A1 of the switching regulator SR and ground. The transistor T1 is controlled by a control unit SE with a pulse width modulated signal.

To generate the control signal, the control unit SE comprises an error amplifier in the form of an operational amplifier OP1 and a sawtooth generator SG. A first reference voltage UR1, which is used as a setpoint value for the output voltage UASR1 of the switching regulator SR, is applied at a first input of operational amplifier OP1 and the output voltage UASR1, which is divided down suitably by a voltage divider, is applied at a second input of operational amplifier OP1. The pulse duty ratio of the pulse width modulated control signal of transistor T1 is adjusted by the control unit SE in such a way that the desired value of the output voltage UASR1 results. The switching regulator SR also includes capacitors C1 and C2, an inductor L2, and a diode D1 in the wiring typical for SEPIC-type converters.

To generate a second unregulated output voltage UASR2, the switching regulator SR comprises a rectifier element in the form of another diode D2 and a smoothing capacitor C3, which is looped in series between a junction point N1 of input inductor L1 and the first transistor T1 and ground, the second output voltage UASR2 being available at junction point N2 of diode D2 and smoothing capacitor C3. The voltage at junction point N1 of input inductor L1 and transistor T1 has periodic voltage spikes during operation, which correspond essentially to the sum of the input voltage UESR and the output voltage UASR1 of the switching regulator SR. The second output voltage UASR2 of the switching regulator SR is obtained herefrom with the help of diode D2 and smoothing capacitor C3 and is higher than the input voltage UESR and the output voltage UASR1 of the switching regulator.

Another rectifier element in the form of another diode D3 is looped in the forward direction between input terminal A1 of the switching regulator SR and node N2. It is used to start the switching regulator, when the input voltage is applied. A possibly not yet available or too low second output voltage UASR2 can then be replaced by the input voltage, which is put through diode D3. Diode D3 is optional and can be omitted depending on the specification to be met.

From the second output voltage UASR2 of the switching regulator SR, with use of a linear voltage regulator LR1, a precise, low-residual-ripple supply voltage for the control element SE and for a control element of another linear voltage regulator LR2 is generated, which in this example is formed by an operational amplifier OP2. If lower requirements are imposed on the quality of this supply voltage, voltage regulator LR1 can be omitted and the second supply voltage UASR2 can serve directly as the supply voltage for the control element SE and operational amplifier OP2. Instead of the linear regulator LR1, a simpler stabilization circuit can also be used.

The linear regulator LR2 is used to generate a system voltage UALR2 and comprises a controllable load element in the form of an NMOS transistor T2, which is supplied at its drain connection with the output voltage UASR1 of the switching regulator SR, and the operational amplifier OP2 whose output voltage is used to control transistor T2. Transistor T2 forms a load current path between the output voltage UASR1 of the switching regulator SR and the output voltage UALR2 of the linear regulator LR2. A reference voltage UR2, which is used for adjusting the output voltage UALR2, is applied at a first input of operational amplifier OP2. The output voltage UALR2, tapped off by a measuring resistor RM and divided down as needed, is back coupled at a second input. Because operational amplifier OP2 is supplied with the output voltage of voltage regulator LR1, which is higher than the output voltage UASR1 of the switching regulator applied at the drain connection of transistor T2, it is also capable of providing control voltages, which are higher than the output voltage UASR1. The maximum gate-source voltage UGS of transistor T2 can be 5 V, for example, depending on the employed technology. Consequently, transistor T2 can be dimensioned accordingly small. Overall, chip area can be saved by this, which reduces manufacturing costs.

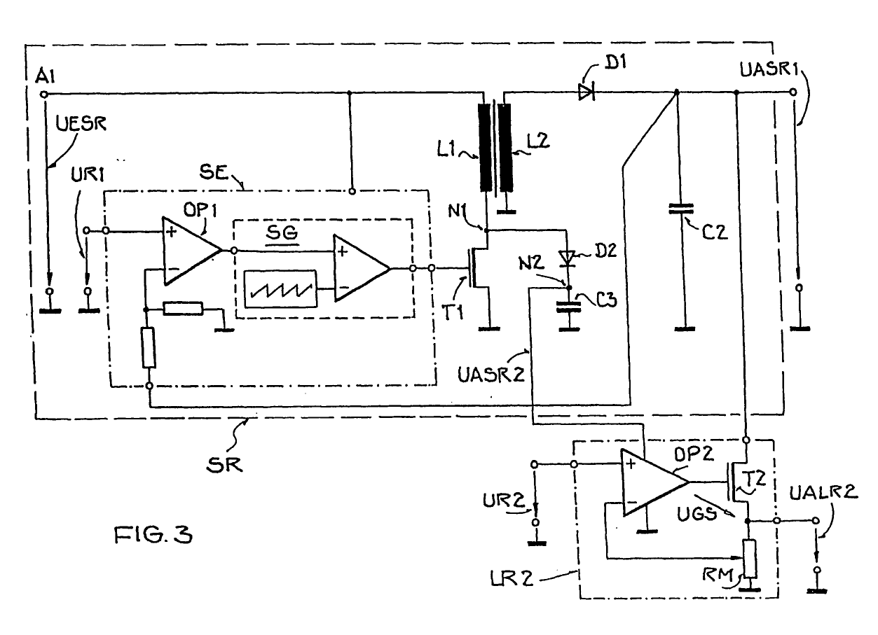

FIG. 3 shows a circuit variant, in which the switching regulator SR is constructed as a so-called flyback converter. Because the function of the shown circuit agrees substantially with the circuit shown in FIG. 2, only the differences will be discussed below.

The input voltage UESR, which is converted to a suitable value within the control unit SE, is used directly as the supply voltage of the control unit SE in this exemplary embodiment. Linear regulator LR1 of FIG. 2 is omitted and the second voltage UASR2 of the switching regulator SR, available at the node N2, is used directly to supply operational amplifier OP2 of the linear voltage regulator LR2. Diode D3 shown in FIG. 2 has been omitted. The second voltage UASR2 is tapped by diode D2 and capacitor C3 at a primary winding of a transformer formed by inductors L1 and L2.

In the shown embodiments, the second output voltage UA2 or UASR2 of the switching regulator SR is used to supply the control element AE or operational amplifier OP2 of the linear voltage regulator LR or LR2. Because of the voltage UA2 or UASR2, which is higher than the first output voltage UA1 or UASR1 of the switching regulator, it is possible to dimension the load element LE or the transistor T2 smaller.

The invention is not limited to the shown exemplary embodiments, however. Thus, the linear voltage regulator LR2 can be replaced, for example, by a regulator or a drive component for an electric motor, in which a power transistor is controlled as the load element in a similar way by a suitable control element.

The switching regulator can also be designed in general as a reverse converter. The second voltage here is basically tapped as shown with the use of a rectifier element and a capacitor connected to ground as a function of the employed converter type either at a node between the switching element and an inductor or a primary winding of a transformer.

The invention makes possible an economically realizable circuit arrangement for a power supply, for example, for vehicles, because the employed load elements due to their improved control can be dimensioned smaller and the operational reliability is assured over a broad input voltage range.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A circuit arrangement for a power supply, the circuit arrangement comprising:
a switching regulator for generating a first regulated voltage;
a controllable load element, which is supplied with the first regulated voltage; and
a first control element for controlling the load element;
wherein the switching regulator is adapted to generate a second unregulated voltage, which serves directly or indirectly as a supply voltage for the first control element.

2. The circuit arrangement according to claim 1, wherein the second unregulated voltage is higher than the first regulated voltage.

3. The circuit arrangement according to claim 1, wherein the controllable load element and the first control element form a first linear voltage regulator to generate a third regulated voltage based on the first voltage.

4. The circuit arrangement according to claim 1, wherein the switching regulator includes a second control element, and wherein the second unregulated voltage serves directly or indirectly as the supply voltage for the second control element.

5. The circuit arrangement according to claim 1, further comprising a second voltage regulator, which generates a supply voltage from the second unregulated voltage for the first control element and/or a second control element.

6. The circuit arrangement according to claim 1, wherein a first rectifier element and a smoothing capacitor are arranged in series between a junction point of an input inductor and a switch and a reference potential of the switching regulator, the second unregulated voltage being available at a junction point between the first rectifier element and the smoothing capacitor.

7. The circuit arrangement according to claim 1, wherein a second rectifier element is provided between an input terminal and a node of the switching regulator, at which the second voltage is available.

8. The circuit arrangement according to claim 1, wherein the controllable load element forms an emitter follower or a source follower.

9. The circuit arrangement according to claim 1, wherein the switching regulator is an SEPIC converter, a flyback converter, or a reverse converter.

10. A method for generating a supply voltage, the method comprising the steps of:
generating a first regulated voltage by a switching regulator;
supplying a controllable load element supplied with the first regulated voltage, which is controlled by a first control element; and
generating a second unregulated voltage by the switching regulator to supply the first control element.

11. The method according to claim 10, wherein the first regulated voltage and the second unregulated voltage are generated in such a way that the second unregulated voltage is higher than the first regulated voltage.

12. The method according to claim 10, wherein the controllable load element is controlled by the first control unit so that a third regulated voltage is generated from the first voltage.

13. The method according to claim 10, wherein a second control element, which controls the switching regulator internally, is supplied directly or indirectly by the second unregulated voltage.

14. The method according to claim 10, wherein a supply voltage for the first control element and/or the second control element is generated from the second voltage.
